(19) United States
(12) Patent Application Publication
(10) Pub. No.: US 2026/0219997 A1
(43) Pub. Date: Jul. 30, 2026

(54) ONBOARDING OF COMPUTE CLUSTER TO BACKUP SYSTEM USING AN AGENT

(71) Applicant: Rubrik, Inc., Palo Alto, CA (US)

(72) Inventors: Sai Sandeep MOPARTHI, Mountain View, CA (US); Gaurav KHANDELWAL, San Jose, CA (US); Rajath SUBRAMANYAM, San Jose, CA (US); Grace Qi, Cupertino, CA (US); Pin ZHOU, San Jose, CA (US); Abhishek DHARMAPURIKAR, San Jose, CA (US)

(21) Appl. No.: 19/036,352

(22) Filed: Jan. 24, 2025

(51) Int. Cl. G06F 11/1446

(52) U.S. Cl. CPC G06F 11/1458; G06F 11/1456

(57) ABSTRACT

Methods, systems, and devices for data management are described. A method may include executing, by a data management system, a command that applies a manifest file to a host computing cluster, where the manifest file defines a backup agent that is to be installed on the host computing cluster; receiving, from the backup agent, information indicative of the backup agent being installed on the host computing cluster; receiving, by the data management system after receiving the information, a first request to back up the host computing cluster; transmitting, to the backup agent installed on the host computing cluster and in response to receiving the first request to back up the host computing cluster, a second request for data of the host computing cluster; and receiving, from the backup agent after transmitting the second request for data, data of the host computing cluster.

### FIELD OF TECHNOLOGY

The present disclosure relates generally to data management, including techniques for onboarding of compute cluster to backup system using an agent.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports onboarding of compute cluster to backup system using an agent in accordance with aspects of the present disclosure.

FIG. 2 shows an example of a computing architecture that supports onboarding of compute cluster to backup system using an agent in accordance with aspects of the present disclosure.

FIG. 3 shows an example of a process flow that supports onboarding of compute cluster to backup system using an agent in accordance with aspects of the present disclosure.

FIG. 4 shows a block diagram of an apparatus that supports onboarding of compute cluster to backup system using an agent in accordance with aspects of the present disclosure.

FIG. 5 shows a block diagram of a backup agent manager that supports onboarding of compute cluster to backup system using an agent in accordance with aspects of the present disclosure.

FIG. 6 shows a diagram of a system including a device that supports onboarding of compute cluster to backup system using an agent in accordance with aspects of the present disclosure.

FIGS. 7 through 9 show flowcharts illustrating methods that support onboarding of compute cluster to backup system using an agent in accordance with aspects of the present disclosure.

### DETAILED DESCRIPTION

Some client environments utilize compute clusters (e.g., Kubernetes clusters) to support and execute applications, and backup systems (e.g., data management systems) may access the resources of the compute clusters to obtain the data to provide backup and recovery services. To access the resources of the compute cluster, the backup system may be provided a specific file type (e.g., Kubeconfig file) that includes access credentials for a client. However, these files may not be long-lived and may result in connectivity issues with the compute cluster, and these connectivity issues may impact the backup/recovery services. Additionally, clients may be hesitant to share these types of files that include credentials due to data security concerns.

Techniques for provisioning an agent that maintains connectivity between the compute cluster and a backup system are described herein. A user may configure a manifest file that includes configuration parameters for installing the agent on the cluster. The manifest file includes an agent definition that results in installation of an agent on the compute cluster, and the agent is configured to accept communications/requests from the designated backup system. Once provisioned, the agent establishes a secure connection with the backup system (e.g., transport layer security (TLS) connection) and communicates cluster information to the backup system so that the backup system is able to manage backup and recovery services. The agent is configured to accept requests from the backup system and forward requests to an application programming interface (API) server of the cluster. The manifest file includes roles that define the privileges used by the backup system to support backup and recovery. These and other techniques are described in further detail with respect to the figures.

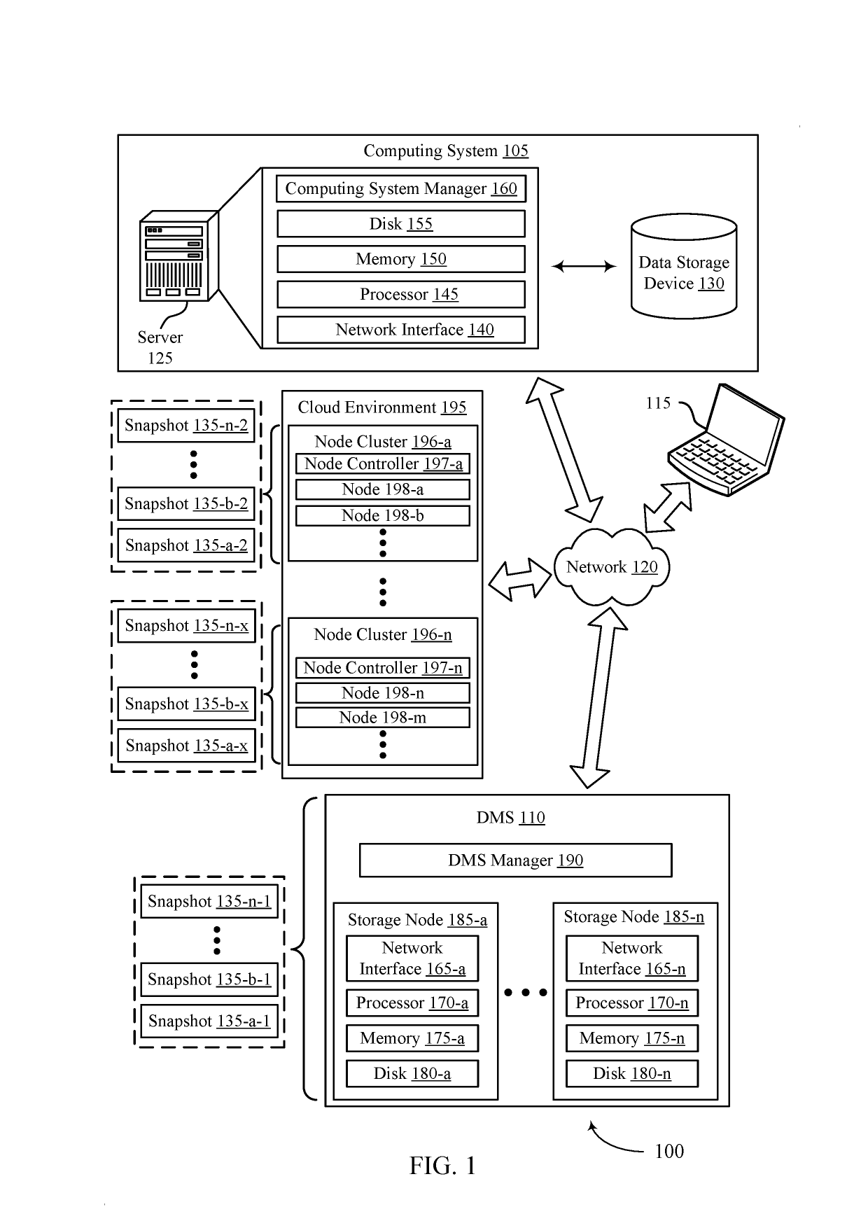

FIG. 1 illustrates an example of a computing environment 100 that supports onboarding of compute cluster to backup system using an agent in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructureas-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant’s data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

As described herein, the DMS 110 may provide backup and/or recovery services for various types of computing environments. For example, the DMS 110 may provide backup and recovery services for a compute cluster (e.g., the computing system 105 is a compute cluster). In such cases, to provide access to the compute cluster, a backup system may be provided a file that contains credentials for accessing the compute cluster. However, these files may not be long-lived and may result in connectivity issues with the compute cluster, and these connectivity issues may impact the backup/recovery services. For example, when the backup system is unable to access the compute cluster due to the file being stale (e.g., expired), the backup system may not be able to provide backup services in accordance with a SLA. Additionally, clients may be hesitant to share these types of files that include credentials due to data security concerns.

Techniques described herein support provisioning an agent (e.g., at the computing system 105) that maintains connectivity between the compute cluster and a backup system (e.g., the DMS 110) are described herein. A user may configure a manifest file that includes configuration parameters for installing the agent on the cluster. The manifest file includes an agent definition that results in installation of an agent on the compute cluster, and the agent is configured to accept communications/requests from the designated backup system. Once provisioned, the agent establishes a secure connection with the backup system (e.g., transport layer security (TLS) connection) and communicates cluster information to the backup system so that the backup system can manage backup services. The agent is configured to accept requests from the backup system and forward requests to an application programming interface (API) server of the cluster (e.g., at the computing system 105). The manifest file includes roles that define the privileges used by the backup system to support backup and recovery. These and other techniques are described in further detail with respect to the figures.

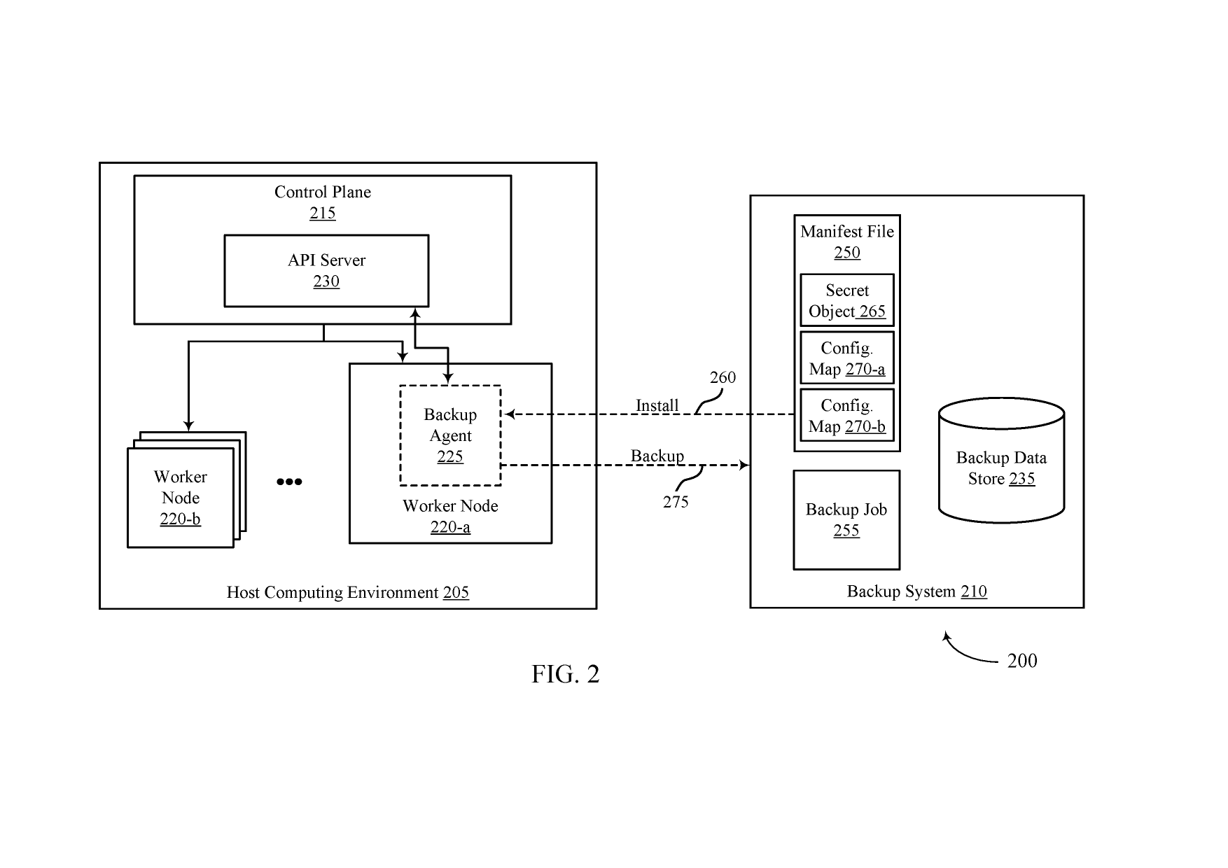

FIG. 2 shows an example of a computing architecture 200 that supports onboarding of compute cluster to backup system using an agent in accordance with aspects of the present disclosure. The computing architecture 200 includes a host computing environment 205 and a backup system 210. The host computing environment 205 may be an example of the computing system 105 of FIG. 1, and the backup system 210 may be an example of aspects of the DMS 110, the cloud environment 195, or both of FIG. 1. The backup system 210 may provide backup services for resources of the host computing environment 205, as described herein.

In some cases, the host computing environment 205 is an example of a cluster based computing system (e.g., Kubernetes), and the host computing environment 205 may be an example of a cluster that includes multiple machines (e.g., nodes, such as worker nodes 220) that run containerized applications. The cluster (e.g., the host computing environment 205) may include a control plane 215, which may be an example of a master node and which controls the cluster such as by scheduling applications on containers of worker nodes 220. The control plane 215 may include an API server 230 (e.g., kube-apiserver) that functions as a front-end of the control plane 215 and may expose the API of the cluster. The API server 230 may perform request processing such as by validating and processing representation state transfer (REST) requests and handles API request from nodes, pods, and other cluster components. The API server 230 may serve as the entry point for external commands. The API server 230 may also authenticate incoming requests and manage admission control among other authentication and authorization functionality.

Each of the nodes, such as the worker nodes 220 and the control plane 215, may be examples of individual machines (e.g., physical or virtual) in the cluster, and each node may include one or more pods that execute one or more containers. The one or more pods include one or more containers that share the same network namespace, allowing the containers to communicate. The containers may be examples of lightweight, standalone packages that includes code, runtime, system tools, libraries, and settings for packing and executing applications. The containers within the pods may share the same IP address, port space, and storage volume, such as to provide data persistence and data sharing. These storage volumes may persist data so that the data may be used by other containers within the pods.

The backup system 210 may support backup services for one or more host computing environments, such as host computing environment 205. A backup system, such as backup system 210, may interact with the host computing environment 205 using a configuration file (e.g., Kubeconfig file), which may support access to resources on the host computing environment 205. However, some cluster based configurations do not permit the creation of long-lived configuration files, which may lead to difficulties in maintaining connectivity between the backup system 210 and the host cluster. Additionally, the configuration file may contain credentials, and clients may be hesitant to share these files for security reasons.

Techniques described herein support access to the host computing environment 205 by the backup system 210 without the concerns of using the configuration files. To support such techniques, a backup agent 225 is installed on the host computing environment 205, and the backup agent 225 may establish a secure communication channel between the backup system 210 and the host computing environment 205.

To install the backup agent 225 on the host computing environment 205, a manifest file 250 is generated on the backup system 210. The manifest file 250 may be an example of a yet another markup language (YAML) or JavaScript object notation (JSON) file that describes the desired state of a cluster object, such as a pods, deployment service, etc. The manifest file may include information for declarative configuration, version control, and resource management, among other information. The manifest file 250 may be generated by an administrator of the backup system 210. The manifest file 250 may include parameters that define the backup agent 225. For example, the manifest file 250 includes a ClusterRole and Roles parameter that are defined to match the least privileges used by the backup system 210 to support backup and recovery services. The manifest file 250 may also include a secret object 265 (e.g., K8s secret) that stores sensitive information, such as passwords, authorization tokens (e.g., OAuth tokens), secure shell (SSH) keys, TLS certificates, and API keys. The secret object may include credentials for the backup system 210 and may have a time-to-live (e.g., 30 minutes). A job within the backup system 210 may ensure that the account credentials for the backup system 210 and included in the secret object expire after the time-to-live.

The manifest file 250 may also include a first configuration map 270-a (e.g., K8s configmap) that includes information that is used to establish a secure communication channel between the cluster (e.g., the host computing environment 205) and the backup system 210. The manifest file may also include a second configuration map 270-b that includes information used to call one or more APIs at the backup system 210 to add or edit information associated with the cluster at the backup system 210. The configuration maps 270 be examples of API objects that are used to store non-confidential configuration data in key-value pairs, and the configuration map may support application configuration, setting up environment variables, storing configuration files, and managing environments.

After the manifest file 250 is defined at the backup system 210, the backup system 210 may execute a command or script that causes installation or application, at 260, of the backup agent 225 on the cluster (e.g., the host computing environment 205). The backup agent may be installed on a worker node, such as worker node 220-a, at the cluster. After the backup agent is installed, the backup agent may check the information in the second configuration map 270-b to identify the API at the backup system 210 add or edit the information for the cluster at the backup system 210 and using information or credentials included in the secret object 265. The backup agent 225 may then call the identified API to add/edit the cluster at the backup system 210.

The backup agent 225 may use a certificate in the configuration map 270-a to start a server with a TLS configuration to accept requests from the backup system 210 using the certificate. The backup agent 225 may use the service account with the least privilege ClusterRole and Role permissions to authenticate with the API server 230. Authentication with the API server 230 may allow the backup agent 225 to forward requests from the backup system 210 to the API server 230 and return responses to the backup system 210.

Thus, when the backup system 210 is to execute a backup job 255 to support backup of aspects of the host computing environment 205 in accordance with an SLA, the backup job 255 may be configured to transmit requests to the backup agent 225 via the TLS connection established by the backup agent 225 with the backup system 210 in accordance with aspects of the manifest file 250. The backup agent may forward the requests to the API server 230, receive responses including backup data, and forward the backup data to the backup system 210 at 275. The backup job 255 may store the received data in a backup data store 235, which may be local backup data or a remote (e.g., cloud-based) data store.

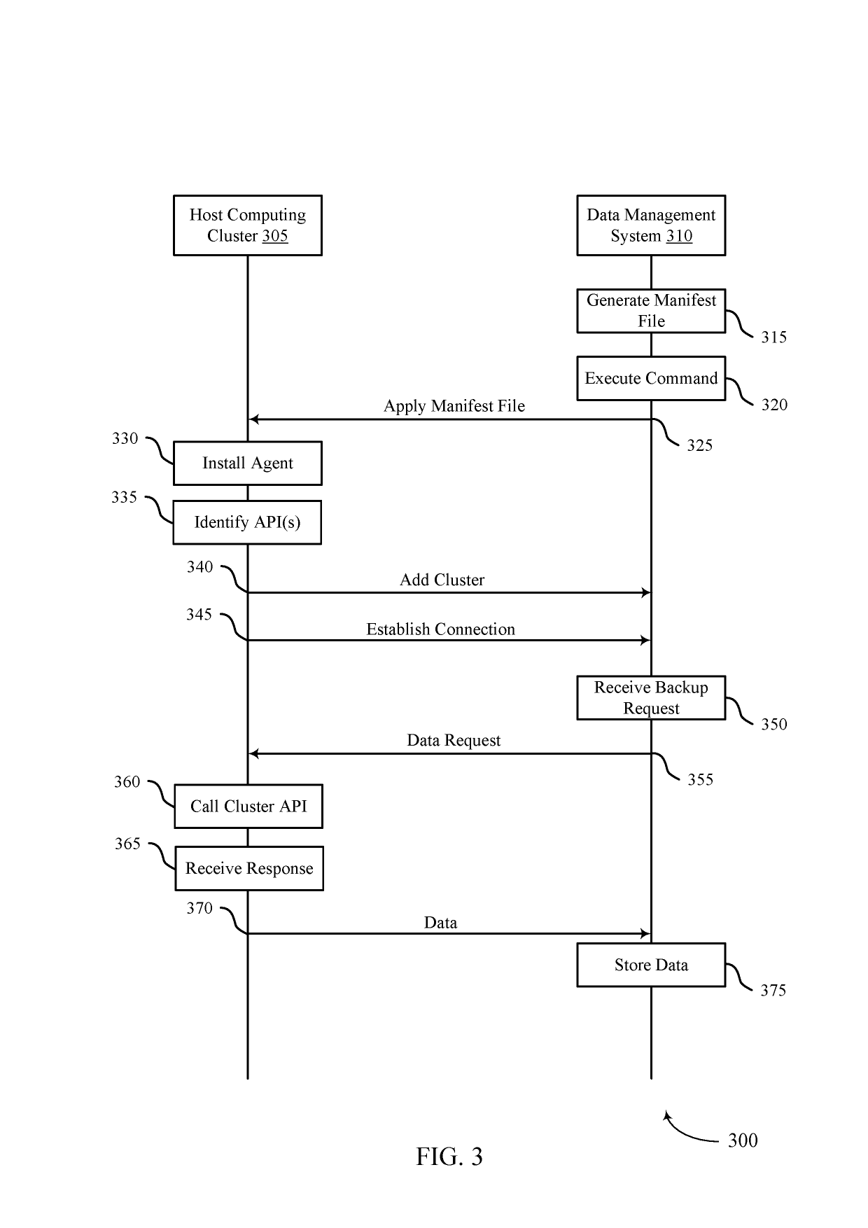

FIG. 3 shows an example of a process flow 300 that supports onboarding of compute cluster to backup system using an agent in accordance with aspects of the present disclosure. The process flow 300 includes a host computing cluster 305 and a data management system 310. The host computing cluster 305 may be an example of the host computing environment 205 of FIG. 2 or the computing system 105 of FIG. 1. The data management system 310 may be an example of the backup system 210 of FIG. 2 or the DMS 110 or the cloud environment 195 of FIG. 1. In the following description of the process flow 300, the operations between the host computing cluster 305 and the data management system 310 may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 315, the data management system 310 may generate a manifest file. The manifest file may be generated based on one or more inputs by a user. For example, a user may provide information (e.g., credentials) or parameters (e.g., roles, permissions, API information, certificates) that are to be included in the manifest file. At 320, the data management system 310 may execute a command that applies, at 325, a manifest file to the host computing cluster 305, where the manifest file defines a backup agent that is to be installed on the host computing cluster 305. The manifest file may include an API object (e.g., configuration map or secret object) that includes an indication of the API endpoint of the data management system 310. The manifest file may also include an object (e.g., secret object) that is encoded and includes a credential associated with accessing or communicating with the data management system 310. The credential set may be used for a configured duration (e.g., time-to-live). The manifest file may also include information indicative of one or more permissions associated with access, by the backup agent, to the API endpoint (e.g., API server) of the host computing cluster 305. Additionally, the manifest file may include an indication of a resource (e.g., worker node) that is to install and execute the backup agent. The manifest file may also include information that indicates that the backup agent is to transmit, to API endpoint of the host computing cluster, API requests in response to receiving requests from the data management system 310.

At 330, the host computing cluster 305 may install the backup agent (e.g., on worker node) as a result of execution of the command. At 335, the backup agent installed on the host computing cluster 305 may identify one or more APIs (e.g., API endpoints) of the data management system 310 based on information included in the manifest file. For example, the one or more APIs may be identified using a configuration map included in the manifest file. At 340, the data management system 310 may receive information indicative of the backup agent being installed on the host computing cluster. For example, the data management system 310 may receive, via an API endpoint, a request to add the cluster to the data management system 310. At 345, the data management system 310 may establish, via the backup agent and using a certificate included in the manifest file, a secure connection (e.g., a TLS connection) with the backup agent on the host computing cluster 305. For example, the backup agent may use the certificate included in the manifest file (e.g., in a configuration map) to start the TLS connection with the data management system 310. Additionally, the API endpoint may be identified by the backup agent based on the indication of the API endpoint included in the API object of the manifest file.

At 350, the data management system 310 may receive a first request to back up the host computing cluster 305. The request may be received from a user interface activated by a user and/or based on execution of a backup job in accordance with a SLA. At 355, the data management system may transmit, to the backup agent installed on the host computing cluster 305 and in response to receiving the first request to back up the host computing cluster, a second request for data of the host computing cluster.

At 360, the backup agent on the host computing cluster 305 may call an API server of the host computing cluster 305 based on the request received from the data management system 310. The agent may use a service account/credential included in the manifest file to authenticate to the API server of the host computing cluster 305 before transmitting the request. The API server may be identified based on information included in the manifest file. At 365, in response to calling the API server, the backup agent may receive data for the backup by the data management system 310. At 370, the backup agent may forward the backup data to the data management system 310, and the data management system may receive, from the backup agent after transmitting the second request for the data, the data of the host computing cluster 305. AT 375, the data management system 310 may store the data in a data store.

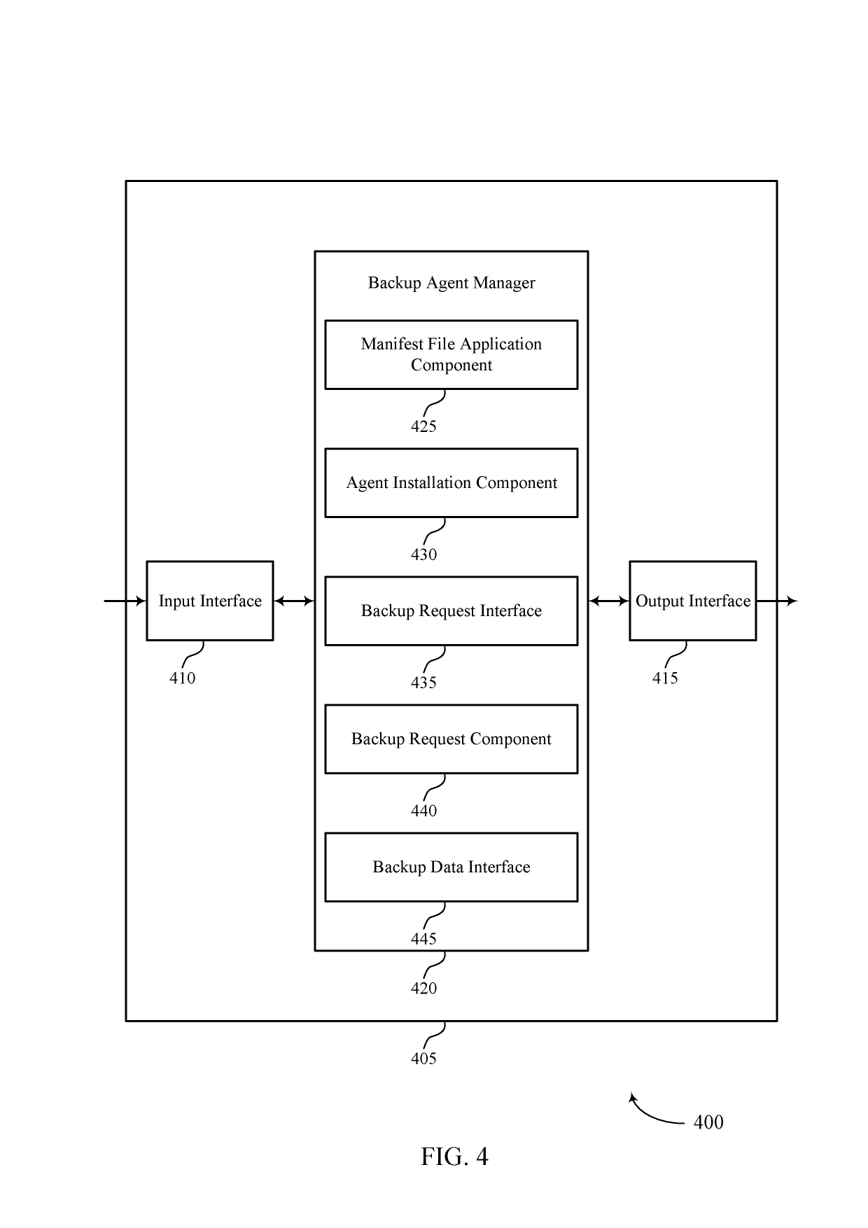

FIG. 4 shows a block diagram 400 of a system 405 that supports onboarding of compute cluster to backup system using an agent in accordance with aspects of the present disclosure. In some examples, the system 405 may be an example of aspects of one or more components described with reference to FIG. 1, such as a DMS 110. The system 405 may include an input interface 410, an output interface 415, and a backup agent manager 420. The system 405 may also include one or more processors. Each of these components may be in communication with one another (e.g., via one or more buses, communications links, communications interfaces, or any combination thereof).

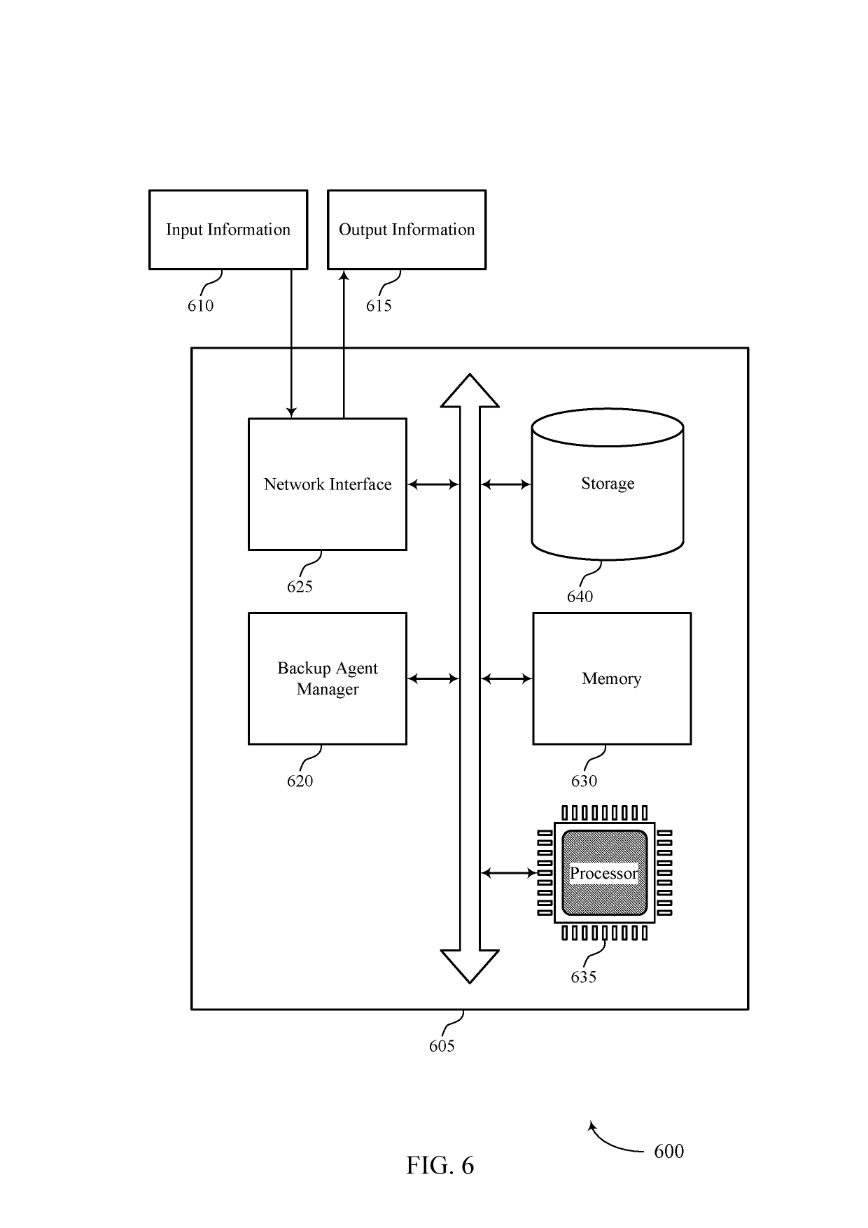

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the backup agent manager 420 to support onboarding of compute cluster to backup system using an agent. In some cases, the input interface 410 may be a component of a network interface 625 as described with reference to FIG. 6.

The output interface 415 may manage output signaling for the system 405. For example, the output interface 415 may receive signaling from other components of the system 405, such as the backup agent manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the backup agent manager 420 may include a manifest file application component 425, an agent installation component 430, a backup request interface 435, a backup request component 440, a backup data interface 445, or any combination thereof. In some examples, the backup agent manager 420, or various components thereof, may be configured to perform various operations (e.g., receiving, monitoring, transmitting) using or otherwise in cooperation with the input interface 410, the output interface 415, or both. For example, the backup agent manager 420 may receive information from the input interface 410, send information to the output interface 415, or be integrated in combination with the input interface 410, the output interface 415, or both to receive information, transmit information, or perform various other operations as described herein.

The manifest file application component 425 may be configured as or otherwise support a means for executing, by a data management system, a command that applies a manifest file to a host computing cluster, where the manifest file defines a backup agent that is to be installed on the host computing cluster. The agent installation component 430 may be configured as or otherwise support a means for receiving, from the backup agent in accordance with the manifest file being applied to the host computing cluster, information indicative of the backup agent being installed on the host computing cluster. The backup request interface 435 may be configured as or otherwise support a means for receiving, by the data management system after receiving the information, a first request to back up the host computing cluster. The backup request component 440 may be configured as or otherwise support a means for transmitting, to the backup agent installed on the host computing cluster and in response to receiving the first request to back up the host computing cluster, a second request for data of the host computing cluster. The backup data interface 445 may be configured as or otherwise support a means for receiving, from the backup agent after transmitting the second request for data, data of the host computing cluster.

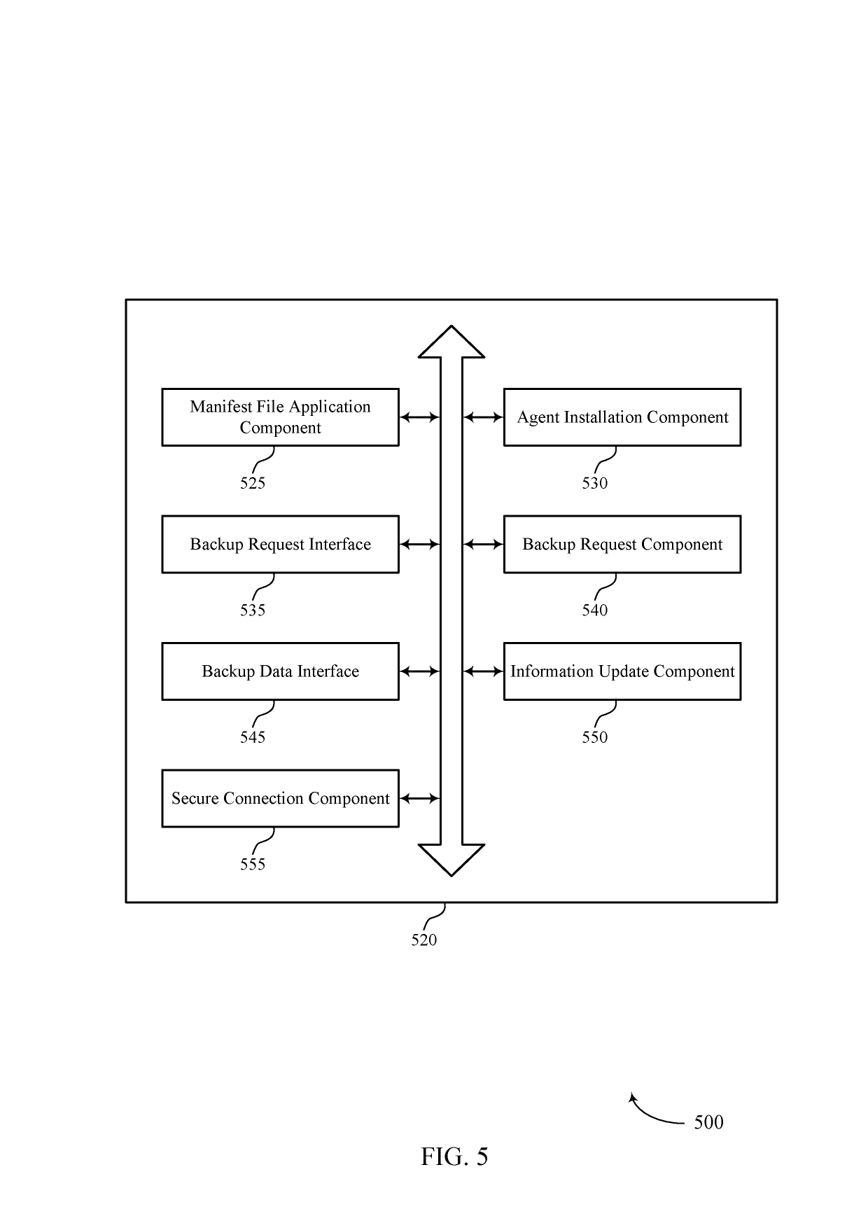

FIG. 5 shows a block diagram 500 of a backup agent manager 520 that supports onboarding of compute cluster to backup system using an agent in accordance with aspects of the present disclosure. The backup agent manager 520 may be an example of aspects of a backup agent manager or a backup agent manager 420, or both, as described herein. The backup agent manager 520, or various components thereof, may be an example of means for performing various aspects of onboarding of compute cluster to backup system using an agent as described herein. For example, the backup agent manager 520 may include a manifest file application component 525, an agent installation component 530, a backup request interface 535, a backup request component 540, a backup data interface 545, an information update component 550, a secure connection component 555, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The manifest file application component 525 may be configured as or otherwise support a means for executing, by a data management system, a command that applies a manifest file to a host computing cluster, where the manifest file defines a backup agent that is to be installed on the host computing cluster. The agent installation component 530 may be configured as or otherwise support a means for receiving, from the backup agent in accordance with the manifest file being applied to the host computing cluster, information indicative of the backup agent being installed on the host computing cluster. The backup request interface 535 may be configured as or otherwise support a means for receiving, by the data management system after receiving the information, a first request to back up the host computing cluster. The backup request component 540 may be configured as or otherwise support a means for transmitting, to the backup agent installed on the host computing cluster and in response to receiving the first request to back up the host computing cluster, a second request for data of the host computing cluster. The backup data interface 545 may be configured as or otherwise support a means for receiving, from the backup agent after transmitting the second request for data, data of the host computing cluster.

In some examples, to support receiving the information, the information update component 550 may be configured as or otherwise support a means for receiving, from the backup agent at an application endpoint, a request to add the information to the data management system for supporting backup of the host computing cluster.

In some examples, the manifest file includes an application programming interface (API) object including an indication of an API endpoint associated with communication, by the backup agent, of the information indicative of the backup agent being installed on the host computing cluster. In some examples, the information is received using the API endpoint included in the API object.

In some examples, the manifest file includes an object that includes a credential set associated with accessing, by the backup agent, the data management system. In some examples, the object that includes the credential set is encoded for application to the host computing cluster.

In some examples, the credential set is usable to access the data management system for a configured duration.

In some examples, the manifest file includes information indicative of one or more permissions associated with access, by the backup agent, to an application programming interface (API) endpoint of the host computing cluster.

In some examples, the manifest file includes a certificate, and the secure connection component 555 may be configured as or otherwise support a means for establishing, with the backup agent installed on the host computing cluster and using the certificate included in the manifest file, a secure connection, where the data of the host computing cluster is received via the secure connection established using the certificate included in the manifest file.

In some examples, the manifest file includes an indication of a resource of the host computing cluster that is to install and execute the backup agent.

In some examples, the manifest file includes information that indicates that the backup agent is to transmit, to an application programming interface (API) endpoint of the host computing cluster, API requests in response to receiving requests from the data management system.

FIG. 6 shows a block diagram 600 of a system 605 that supports onboarding of compute cluster to backup system using an agent in accordance with aspects of the present disclosure. The system 605 may be an example of or include components of a system 405 as described herein. The system 605 may include components for data management, including components such as a backup agent manager 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting onboarding of compute cluster to backup system using an agent). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the backup agent manager 620 may be configured as or otherwise support a means for executing, by a data management system, a command that applies a manifest file to a host computing cluster, where the manifest file defines a backup agent that is to be installed on the host computing cluster. The backup agent manager 620 may be configured as or otherwise support a means for receiving, from the backup agent in accordance with the manifest file being applied to the host computing cluster, information indicative of the backup agent being installed on the host computing cluster. The backup agent manager 620 may be configured as or otherwise support a means for receiving, by the data management system after receiving the information, a first request to back up the host computing cluster. The backup agent manager 620 may be configured as or otherwise support a means for transmitting, to the backup agent installed on the host computing cluster and in response to receiving the first request to back up the host computing cluster, a second request for data of the host computing cluster. The backup agent manager 620 may be configured as or otherwise support a means for receiving, from the backup agent after transmitting the second request for data, data of the host computing cluster.

By including or configuring the backup agent manager 620 in accordance with examples as described herein, the system 605 may support techniques for onboarding of compute cluster to backup system using an agent, which may provide one or more benefits such as, for example, improved security (by avoiding sharing configuration file credentials) and improve backup efficiency (e.g., by limiting connection dropping as a result of short-lived configuration files), among other possibilities.

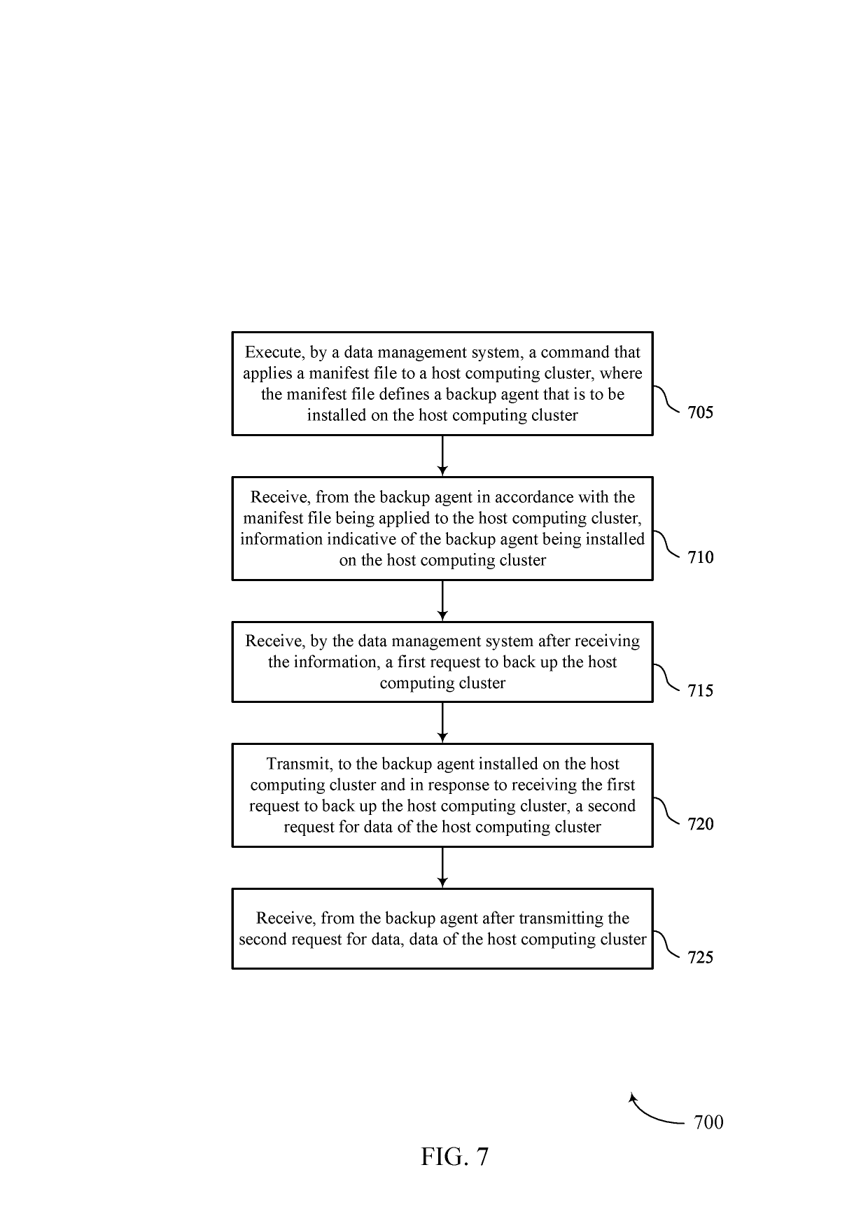

FIG. 7 shows a flowchart illustrating a method 700 that supports onboarding of compute cluster to backup system using an agent in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include executing, by a data management system, a command that applies a manifest file to a host computing cluster, where the manifest file defines a backup agent that is to be installed on the host computing cluster. The operations of 705 may be performed in accordance with examples as disclosed herein. In some examples, aspects of the operations of 705 may be performed by a manifest file application component 525 as described with reference to FIG. 5.

At 710, the method may include receiving, from the backup agent in accordance with the manifest file being applied to the host computing cluster, information indicative of the backup agent being installed on the host computing cluster. The operations of 710 may be performed in accordance with examples as disclosed herein. In some examples, aspects of the operations of 710 may be performed by an agent installation component 530 as described with reference to FIG. 5.

At 715, the method may include receiving, by the data management system after receiving the information, a first request to back up the host computing cluster. The operations of 715 may be performed in accordance with examples as disclosed herein. In some examples, aspects of the operations of 715 may be performed by a backup request interface 535 as described with reference to FIG. 5.

At 720, the method may include transmitting, to the backup agent installed on the host computing cluster and in response to receiving the first request to back up the host computing cluster, a second request for data of the host computing cluster. The operations of 720 may be performed in accordance with examples as disclosed herein. In some examples, aspects of the operations of 720 may be performed by a backup request component 540 as described with reference to FIG. 5.

At 725, the method may include receiving, from the backup agent after transmitting the second request for data, data of the host computing cluster. The operations of 725 may be performed in accordance with examples as disclosed herein. In some examples, aspects of the operations of 725 may be performed by a backup data interface 545 as described with reference to FIG. 5.

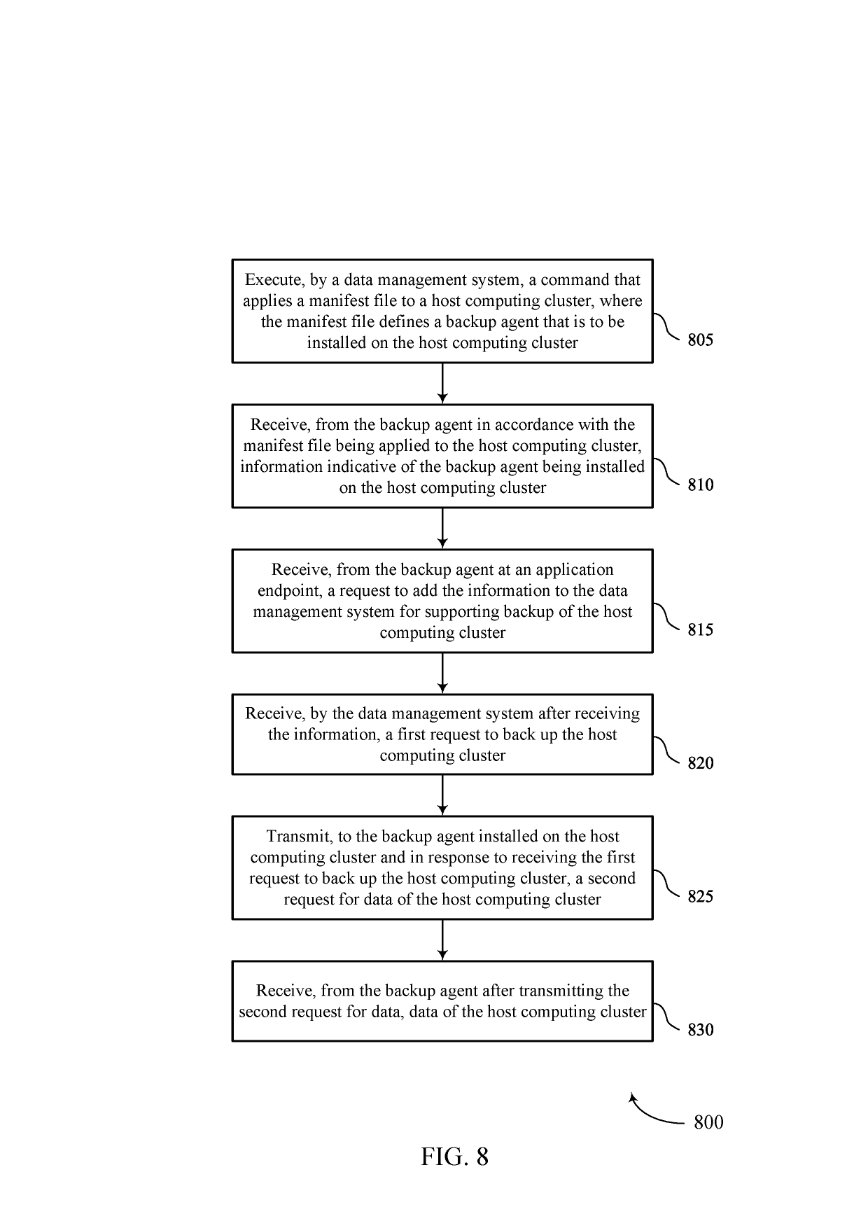

FIG. 8 shows a flowchart illustrating a method 800 that supports onboarding of compute cluster to backup system using an agent in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include executing, by a data management system, a command that applies a manifest file to a host computing cluster, where the manifest file defines a backup agent that is to be installed on the host computing cluster. The operations of 805 may be performed in accordance with examples as disclosed herein. In some examples, aspects of the operations of 805 may be performed by a manifest file application component 525 as described with reference to FIG. 5.

At 810, the method may include receiving, from the backup agent in accordance with the manifest file being applied to the host computing cluster, information indicative of the backup agent being installed on the host computing cluster. The operations of 810 may be performed in accordance with examples as disclosed herein. In some examples, aspects of the operations of 810 may be performed by an agent installation component 530 as described with reference to FIG. 5.

At 815, the method may include receiving, from the backup agent at an application endpoint, a request to add the information to the data management system for supporting backup of the host computing cluster. The operations of 815 may be performed in accordance with examples as disclosed herein. In some examples, aspects of the operations of 815 may be performed by an information update component 550 as described with reference to FIG. 5.

At 820, the method may include receiving, by the data management system after receiving the information, a first request to back up the host computing cluster. The operations of 820 may be performed in accordance with examples as disclosed herein. In some examples, aspects of the operations of 820 may be performed by a backup request interface 535 as described with reference to FIG. 5.

At 825, the method may include transmitting, to the backup agent installed on the host computing cluster and in response to receiving the first request to back up the host computing cluster, a second request for data of the host computing cluster. The operations of 825 may be performed in accordance with examples as disclosed herein. In some examples, aspects of the operations of 825 may be performed by a backup request component 540 as described with reference to FIG. 5.

At 830, the method may include receiving, from the backup agent after transmitting the second request for data, data of the host computing cluster. The operations of 830 may be performed in accordance with examples as disclosed herein. In some examples, aspects of the operations of 830 may be performed by a backup data interface 545 as described with reference to FIG. 5.

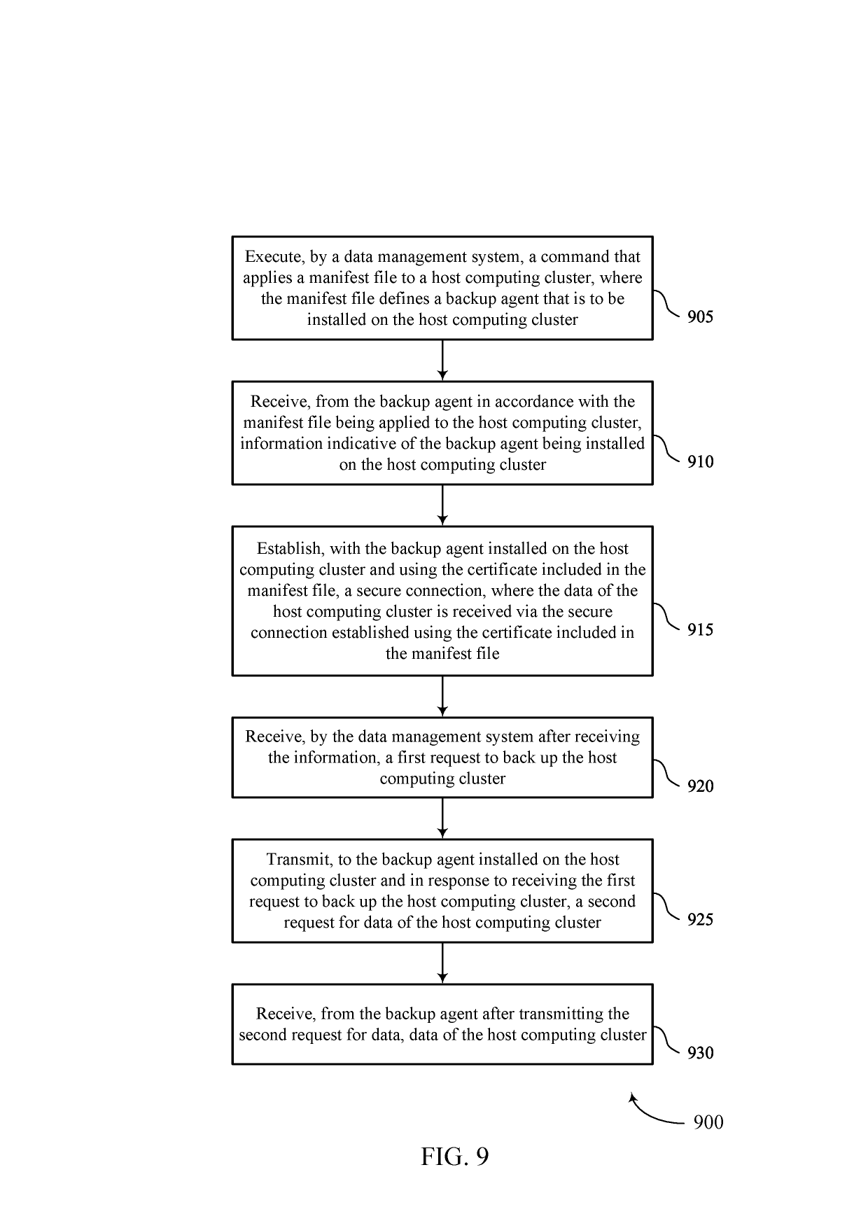

FIG. 9 shows a flowchart illustrating a method 900 that supports onboarding of compute cluster to backup system using an agent in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include executing, by a data management system, a command that applies a manifest file to a host computing cluster, where the manifest file defines a backup agent that is to be installed on the host computing cluster. The operations of 905 may be performed in accordance with examples as disclosed herein. In some examples, aspects of the operations of 905 may be performed by a manifest file application component 525 as described with reference to FIG. 5.

At 910, the method may include receiving, from the backup agent in accordance with the manifest file being applied to the host computing cluster, information indicative of the backup agent being installed on the host computing cluster. The operations of 910 may be performed in accordance with examples as disclosed herein. In some examples, aspects of the operations of 910 may be performed by an agent installation component 530 as described with reference to FIG. 5.

At 915, the method may include establishing, with the backup agent installed on the host computing cluster and using the certificate included in the manifest file, a secure connection, where the data of the host computing cluster is received via the secure connection established using the certificate included in the manifest file. The operations of 915 may be performed in accordance with examples as disclosed herein. In some examples, aspects of the operations of 915 may be performed by a secure connection component 555 as described with reference to FIG. 5.

At 920, the method may include receiving, by the data management system after receiving the information, a first request to back up the host computing cluster. The operations of 920 may be performed in accordance with examples as disclosed herein. In some examples, aspects of the operations of 920 may be performed by a backup request interface 535 as described with reference to FIG. 5.

At 925, the method may include transmitting, to the backup agent installed on the host computing cluster and in response to receiving the first request to back up the host computing cluster, a second request for data of the host computing cluster. The operations of 925 may be performed in accordance with examples as disclosed herein. In some examples, aspects of the operations of 925 may be performed by a backup request component 540 as described with reference to FIG. 5.

At 930, the method may include receiving, from the backup agent after transmitting the second request for data, data of the host computing cluster. The operations of 930 may be performed in accordance with examples as disclosed herein. In some examples, aspects of the operations of 930 may be performed by a backup data interface 545 as described with reference to FIG. 5.

The following provides an overview of aspects of the present disclosure:

Aspect 1: A method, comprising: executing, by a data management system, a command that applies a manifest file to a host computing cluster, wherein the manifest file defines a backup agent that is to be installed on the host computing cluster; receiving, from the backup agent in accordance with the manifest file being applied to the host computing cluster, information indicative of the backup agent being installed on the host computing cluster; receiving, by the data management system after receiving the information, a first request to back up the host computing cluster; transmitting, to the backup agent installed on the host computing cluster and in response to receiving the first request to back up the host computing cluster, a second request for data of the host computing cluster; and receiving, from the backup agent after transmitting the second request for data, data of the host computing cluster.

Aspect 2: The method of aspect 1, wherein receiving the information comprises: receiving, from the backup agent at an application endpoint, a request to add the information to the data management system for supporting backup of the host computing cluster.

Aspect 3: The method of any of aspects 1 through 2, wherein the manifest file comprises an application programming interface (API) object comprising an indication of an API endpoint associated with communication, by the backup agent, of the information indicative of the backup agent being installed on the host computing cluster, the information is received using the API endpoint included in the API object.

Aspect 4: The method of any of aspects 1 through 3, wherein the manifest file comprises an object that includes a credential set associated with accessing, by the backup agent, the data management system, the object that includes the credential set is encoded for application to the host computing cluster.

Aspect 5: The method of aspect 4, wherein the credential set is usable to access the data management system for a configured duration.

Aspect 6: The method of any of aspects 1 through 5, wherein the manifest file comprises information indicative of one or more permissions associated with access, by the backup agent, to an application programming interface (API) endpoint of the host computing cluster.

Aspect 7: The method of any of aspects 1 through 6, wherein the manifest file comprises a certificate, the method further comprising: establishing, with the backup agent installed on the host computing cluster and using the certificate included in the manifest file, a secure connection, wherein the data of the host computing cluster is received via the secure connection established using the certificate included in the manifest file.

Aspect 8: The method of any of aspects 1 through 7, wherein the manifest file comprises an indication of a resource of the host computing cluster that is to install and execute the backup agent.

Aspect 9: The method of any of aspects 1 through 8, wherein the manifest file includes information that indicates that the backup agent is to transmit, to an application programming interface (API) endpoint of the host computing cluster, API requests in response to receiving requests from the data management system.

Aspect 10: An apparatus comprising one or more memories storing processor-executable code, and one or more processors coupled with the one or more memories and individually or collectively operable to execute the code to cause the apparatus to perform a method of any of aspects 1 through 9.

Aspect 11: An apparatus comprising at least one means for performing a method of any of aspects 1 through 9.

Aspect 12: A non-transitory computer-readable medium storing code the code comprising instructions executable by one or more processors to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
executing, by a data management system, a command that applies a manifest file to a host computing cluster, wherein the manifest file defines a backup agent that is to be installed on the host computing cluster;
receiving, from the backup agent in accordance with the manifest file being applied to the host computing cluster, information indicative of the backup agent being installed on the host computing cluster;
receiving, by the data management system after receiving the information, a first request to back up the host computing cluster;
transmitting, to the backup agent installed on the host computing cluster and in response to receiving the first request to back up the host computing cluster, a second request for data of the host computing cluster; and
receiving, from the backup agent after transmitting the second request for data, data of the host computing cluster.

2. The method of claim 1, wherein receiving the information comprises:
receiving, from the backup agent at an application endpoint, a request to add the information to the data management system for supporting backup of the host computing cluster.

3. The method of claim 1, wherein:
the manifest file comprises an application programming interface (API) object comprising an indication of an API endpoint associated with communication, by the backup agent, of the information indicative of the backup agent being installed on the host computing cluster, and
the information is received using the API endpoint included in the API object.

4. The method of claim 1, wherein:
the manifest file comprises an object that includes a credential set associated with accessing, by the backup agent, the data management system, and
the object that includes the credential set is encoded for application to the host computing cluster.

5. The method of claim 4, wherein the credential set is usable to access the data management system for a configured duration.

6. The method of claim 1, wherein the manifest file comprises information indicative of one or more permissions associated with access, by the backup agent, to an application programming interface (API) endpoint of the host computing cluster.

7. The method of claim 1, wherein the manifest file comprises a certificate, the method further comprising:
establishing, with the backup agent installed on the host computing cluster and using the certificate included in the manifest file, a secure connection, wherein the data of the host computing cluster is received via the secure connection established using the certificate included in the manifest file.

8. The method of claim 1, wherein the manifest file comprises an indication of a resource of the host computing cluster that is to install and execute the backup agent.

9. The method of claim 1, wherein the manifest file includes information that indicates that the backup agent is to transmit, to an application programming interface (API) endpoint of the host computing cluster, API requests in response to receiving requests from the data management system.

10. An apparatus, comprising:
one or more memories storing processor-executable code; and
one or more processors coupled with the one or more memories and individually or collectively operable to execute the code to cause the apparatus to:
execute, by a data management system, a command that applies a manifest file to a host computing cluster, wherein the manifest file defines a backup agent that is to be installed on the host computing cluster;
receive, from the backup agent in accordance with the manifest file being applied to the host computing cluster, information indicative of the backup agent being installed on the host computing cluster;
receive, by the data management system after receiving the information, a first request to back up the host computing cluster;
transmit, to the backup agent installed on the host computing cluster and in response to receiving the first request to back up the host computing cluster, a second request for data of the host computing cluster; and
receive, from the backup agent after transmitting the second request for data, data of the host computing cluster.

11. The apparatus of claim 10, wherein, to receive the information, the one or more processors are individually or collectively operable to execute the code to cause the apparatus to:
receive, from the backup agent at an application endpoint, a request to add the information to the data management system for supporting backup of the host computing cluster.

12. The apparatus of claim 10, wherein:
the manifest file comprises an application programming interface (API) object comprising an indication of an API endpoint associated with communication, by the backup agent, of the information indicative of the backup agent being installed on the host computing cluster, and
the information is received using the API endpoint included in the API object.

13. The apparatus of claim 10, wherein:
the manifest file comprises an object that includes a credential set associated with accessing, by the backup agent, the data management system, and
the object that includes the credential set is encoded for application to the host computing cluster.

14. The apparatus of claim 13, wherein the credential set is usable to access the data management system for a configured duration.

15. The apparatus of claim 10, wherein the manifest file comprises information indicative of one or more permissions associated with access, by the backup agent, to an application programming interface (API) endpoint of the host computing cluster.

16. A non-transitory computer-readable medium storing code, the code comprising instructions executable by one or more processors to:
execute, by a data management system, a command that applies a manifest file to a host computing cluster, wherein the manifest file defines a backup agent that is to be installed on the host computing cluster;
receive, from the backup agent in accordance with the manifest file being applied to the host computing cluster, information indicative of the backup agent being installed on the host computing cluster;
receive, by the data management system after receiving the information, a first request to back up the host computing cluster;
transmit, to the backup agent installed on the host computing cluster and in response to receiving the first request to back up the host computing cluster, a second request for data of the host computing cluster; and
receive, from the backup agent after transmitting the second request for data, data of the host computing cluster.

17. The non-transitory computer-readable medium of claim 16, wherein the instructions to receive the information are executable by the one or more processors to:
receive, from the backup agent at an application endpoint, a request to add the information to the data management system for supporting backup of the host computing cluster.

18. The non-transitory computer-readable medium of claim 16, wherein:
the manifest file comprises an application programming interface (API) object comprising an indication of an API endpoint associated with communication, by the backup agent, of the information indicative of the backup agent being installed on the host computing cluster, and
the information is received using the API endpoint included in the API object.

19. The non-transitory computer-readable medium of claim 16, wherein:
the manifest file comprises an object that includes a credential set associated with accessing, by the backup agent, the data management system, and
the object that includes the credential set is encoded for application to the host computing cluster.

20. The non-transitory computer-readable medium of claim 19, wherein the credential set is usable to access the data management system for a configured duration.
